(19) United States
(12) Patent Application Publication
(10) Pub. No.: US 2013/0203948 A1
(43) Pub. Date: Aug. 8, 2013

(54) PROCESS FOR THE PREPARATION OF HIGH PURITY PROPYLENE POLYMERS

(71) Applicants: Joachim T.M. Pater, Ferrara (IT); Simona Guidotti, Bologna (IT); Alessandro Mignogna, Bologna (IT); Giampiero Morini, Ferrara (IT); Gianni Vitale, Ferrara (IT)

(72) Inventors: Joachim T.M. Pater, Ferrara (IT); Simona Guidotti, Bologna (IT); Alessandro Mignogna, Bologna (IT); Giampiero Morini, Ferrara (IT); Gianni Vitale, Ferrara (IT)

(73) Assignee: Basell Poliolefine Italia S.r.l., Milano (IT)

(21) Appl. No.: 13/879,998

(22) PCT Filed: Oct. 17, 2011
(86) PCT No.: PCT/EP2011/068084

§ 371 Date: Apr. 17, 2013

Related U.S. Application Data
(60) Provisional application No. 61/405,680, filed on Oct. 22, 2010.

(30) Foreign Application Priority Data
Oct. 19, 2010 (EP) 10187998.8

(51) Int. Cl. C08F 10/06

(52) U.S. Cl. CPC C08F 10/06
USPC 526/111

(57) ABSTRACT

A process for the preparation of high purity propylene polymers carried out in the presence of a catalyst comprising the product obtained by reacting:—an organo-aluminium compound, with—a solid catalyst component comprising Mg, Ti and electron donor compound selected from specific diolesters, said process being carried out employing an organo-aluminum/propylene ratio equal to or lower than 1.75 mmole/kg.

The present invention relates to a process for the preparation of high purity propylene (co)polymers.

With the term high purity propylene copolymers are meant those propylene (co)polymers having a low amount of catalyst residues also called low ash (co)polymers. Preferably the total amount of ashes, including Ti, Mg, Cl and Al, is lower than 50 ppm and preferably lower than 40 ppm.

The titanium content is generally lower than 2 ppm, preferably lower than 1.5 ppm. The Al content is lower than 40, preferably lower than 30 and more preferably lower than 20 ppm. Moreover, said high purity propylene (co)polymers should contain chlorine atoms in an amount lower than 12 ppm and preferably lower than 10 ppm, while the amount of Mg is lower than 4 and preferably lower than 3 ppm.

Propylene polymers with high purity are generally used for film applications and in particular for the production of films for dielectric capacitors. In order to be used for such application the polymers also need to show a medium broad molecular weight distribution and relatively high cristallinity.

As most of the catalysts industrially used are not able to generate polymers with such a low amount of catalyst residues, the propylene polymers need to be purified with deashing treatments which however make the entire process much more complicated from an operational point of view.

One option in order to solve the problem is to operate with lower amounts of aluminum

compound as cocatalyst in order to limit the Al residue in the final polymer.

In WO2009/077467 it is described a process for the preparation of propylene polymers carried out in the presence of a catalyst component based on succinates as internal donors.

The process is characterized by the use of low Al/Ti molar ratio and the polymers obtained although showing a low final content of Al also show a too high amount of Cl and Mg.

It is therefore still felt the need of a process for the production of high purity propylene polymers having a medium broad molecular weight distribution, high cristallinity and low ashes particularly in terms of Mg and Cl.

The applicant has found that a process characterized by combining the use of a solid catalyst component containing a specific internal donor and a specific amount of aluminum alkyl is able to solve the problem.

Hence, it is an object of the present invention a process for the preparation of high purity propylene (co)polymers comprising (co)polymerizing propylene in the presence of a catalyst system comprising the product obtained by reacting:
an organo-aluminium compound, with
a solid catalyst component comprising Mg, Ti and electron donor compound of the following formula (A)

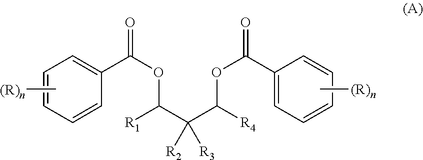

in which R₁-R₄ groups, equal to or different from each other, are hydrogen or C₁-C₁₅ hydrocarbon groups, optionally containing a heteroatom selected from halogen, P, S, N and Si, with the proviso that R₁ and R₄ are not hydrogen; R groups equal to or different from each other, are selected from C₁-C₁₅ hydrocarbon groups which can be optionally linked to form a cycle and n is an integer from 0 to 5, and optionally
an external electron donor compound,
said process being carried out employing an organo-aluminum/propylene ratio equal to or lower than 1.75 mmole/kg.

Preferably, the process is carried out at organo-aluminum/propylene ratio lower than 0.9, more preferably lower than 0.4 and especially in the range of from 0.04 to 0.40 mmole/kg.

Preferably, in the electron donor of formula (A), R₁ and R₄ are selected from C₁-C₁₀ alkyl groups and even more preferably from C₁-C₅ alkyl groups in particular methyl.

Preferably, in the electron donor of formula (A) R₂-R₃ groups independently are selected from hydrogen, C₁-C₁₅ alkyl groups, C₆-C₁₄ aryl groups, C₃-C₁₅ cycloalkyl groups, and C₇-C₁₅ arylalkyl or alkylaryl groups. More preferably, R₂ and R₃ are selected from hydrogen or C₁-C₁₀ alkyl groups and even more preferably from hydrogen or C₁-C₅ alkyl groups in particular methyl. In one preferred embodiment, hydrogen and methyl are preferred. In one particular embodiment both R₂ and R₃ are hydrogen.

Preferably, in the electron donor of formula (A), R groups are selected from C₁-C₁₅ alkyl groups, C₆-C₁₄ aryl groups, C₃-C₁₅ cycloalkyl groups, and C₇-C₁₅ arylalkyl or alkylaryl groups. More preferably, R is selected from C₁-C₁₀ alkyl groups and even more preferably from C₁-C₅ alkyl groups. Among them particularly preferred are methyl, ethyl, n-propyl and n-butyl. The index n can vary from 0 to 5 inclusive, preferably it ranges from 1 to 3 and more preferably is 1. When nisi, the substituent R is preferably in position 4 of the benzoate ring.

Moreover, in the electron donor of formula (A), preferred structures are those in which simultaneously R₁ and R₄ are methyl, R₂ and R₃ are hydrogen and n is 1 and the R groups, which are in position 4 of the benzene ring are methyl, ethyl, n-propyl or n-butyl.

Non limiting examples of structures (A) are the following: 2,4-pentanediol dibenzoate, 3-methyl-2,4-pentanediol dibenzoate, 3-ethyl-2,4-pentanediol dibenzoate, 3-n-propyl-2,4-pentanediol dibenzoate, 3-i-propyl-2,4-pentanediol dibenzoate, 3-n-butyl-2,4-pentanediol dibenzoate, 3-i-butyl-2,4-pentanediol dibenzoate, 3-t-butyl-2,4-pentanediol dibenzoate, 3-n-pentyl-2,4-pentanediol dibenzoate, 3-i-pentyl-2,4-pentanediol dibenzoate, 3-cyclopentyl-2,4-pentanediol dibenzoate, 3-cyclohexyl-2,4-pentanediol dibenzoate, 3-phenyl-2,4-pentanediol dibenzoate, 3-(2-naphtyl)-2,4-pentanediol dibenzoate, 3-allyl-2,4-pentanediol dibenzoate, 3,3-dimethyl-2,4-pentanediol dibenzoate, 3-ethyl-3-methyl-2,4-pentanediol dibenzoate, 3-methyl-3-i-propyl-2,4-pentanediol dibenzoate, 3,3-diisopropyl-2,4-pentanediol dibenzoate, 3-i-pentyl-2-i-propyl-2,4-pentanediol dibenzoate, 3,5-heptanediol dibenzoate, 4,6-nonanediol dibenzoate, 2,6-dimethyl-3,5-heptanediol dibenzoate, 5,7-undecanediol dibenzoate, 2,8-dimethyl-4,6-nonanediol dibenzoate, 2,2,6,6,tetramethyl-3,5-hetanediol dibenzoate, 2,4-hexanediol dibenzoate, 2,4-heptanediol dibenzoate, 2-methyl-3,5-hexanediol dibenzoate, 2,4-octanediol dibenzoate, 2-methyl-4,6-heptanediol dibenzoate, 2,2-dimethyl-3,5-hexanediol dibenzoate, 2-methyl-5,7-octanediol dibenzoate, 2,4-nonanediol dibenzoate, 2,4-pentanediol-bis(4-methylbenzoate), 2,4-pentanediol-bis(3-methylbenzoate), 2,4-pentanediol-bis(4-ethylbenzoate), 2,4-pentanediol-bis(4-n-propylbenzoate), 2,4-pentanediol-bis(4-n-butylbenzoate), 2,4-pentanediol-bis(4-i-propylbenzoate), 2,4-pentanediol-bis(4-i-butylbenzoate), 2,4-pentanediol-bis(4-t-butylbenzoate), 2,4-pentanediol-bis(4-phenylbenzoate), 2,4-pentanediol-bis(3,4-dimethylbenzoate), 2,4-pentanediol-bis(2,4,6-trimethylbenzoate), 2,4-pentanediol-bis(2,6-dimethylbenzoate), 2,4-pentanediol-di-(2-naphthoate), 3-methyl-2,4-pentanediol-bis(4-n-propylbenzoate), 3-i-pentyl-2,4-pentanediol-bis(4-n-propylbenzoate), 1,1,1,5,5,5-hexafluoro-2,4-pentanediol-bis(4-ethylbenzoate), 1,1,1-trifluoro-2,4-pentanediol-bis(4-ethylbenzoate), 1,3-bis(4-chlorophenyl)-1,3 -propanediol-bis(4-ethylbenzoate), 1,1 -difluoro-4-phenyl-2,4-butandiol-bis(4-n-propylbenzoate), 1,1,1-trifluoro-5,5-dimethyl-2,4-hexandiol-bis(4-n-propylbenzoate), 3-chloro-2,4-pentanediol-bis(4-n-propylbenzoate)

As explained above, the catalyst components of the invention comprise, in addition to the above electron donors, Ti, Mg and halogen. In particular, the catalyst components comprise a titanium compound, having at least a Ti-halogen bond and the above mentioned electron donor compounds supported on a Mg halide. The magnesium halide is preferably MgCl₂ in active form which is widely known from the patent literature as a support for Ziegler-Natta catalysts. Patents U.S. Pat. No. 4,298,718 and U.S. Pat. No. 4,495,338 were the first to describe the use of these compounds in Ziegler-Natta catalysis. It is known from these patents that the magnesium dihalides in active form used as support or co-support in components of catalysts for the polymerization of olefins are characterized by X-ray spectra in which the most intense diffraction line that appears in the spectrum of the non-active halide is diminished in intensity and is replaced by a halo whose maximum intensity is displaced towards lower angles relative to that of the more intense line.

The preferred titanium compounds used in the catalyst component of the present invention are TiCl₄ and TiCl₃; furthermore, also Ti-haloalcoholates of formula Ti(OR)_{m-y}X_{y} can be used, where m is the valence of titanium, y is a number between 1 and m-1, X is halogen and R is a hydrocarbon radical having from 1 to 10 carbon atoms.

The preparation of the solid catalyst component can be carried out according to several methods. One method comprises the reaction between magnesium alcoholates or chloroalcoholates (in particular chloroalcoholates prepared according to U.S. Pat. No. 4,220,554) and an excess of TiCl₄ in the presence of the electron donor compounds at a temperature of about 80 to 135° C.

According to a preferred method, the solid catalyst component can be prepared by reacting a titanium compound of formula Ti(OR)_{m-y}X_{y}, where m is the valence of titanium and y is a number between 1 and m, preferably TiCl₄, with a magnesium chloride deriving from an adduct of formula MgCl₂. pROH, where p is a number between 0.1 and 6, preferably from 2 to 3.5, and R is a hydrocarbon radical having 1-18 carbon atoms. The adduct can be suitably prepared in spherical form by mixing alcohol and magnesium chloride in the presence of an inert hydrocarbon immiscible with the adduct, operating under stirring conditions at the melting temperature of the adduct (100-130° C.). Then, the emulsion is quickly quenched, thereby causing the solidification of the adduct in form of spherical particles. Examples of spherical adducts prepared according to this procedure are described in U.S. Pat. No. 4,399,054 and U.S. Pat. No. 4,469,648. The so obtained adduct can be directly reacted with Ti compound or it can be previously subjected to thermal controlled dealcoholation (80-130° C.) so as to obtain an adduct in which the number of moles of alcohol is generally lower than 3, preferably between 0.1 and 2.5. The reaction with the Ti compound can be carried out by suspending the adduct (dealcoholated or as such) in cold TiCl₄ (generally 0° C.); the mixture is heated up to 80-135° C. and kept at this temperature for 0.5-2 hours. The treatment with TiCl₄ can be carried out one or more times. The electron donor compound is preferably added during the treatment with TiCl₄. The preparation of catalyst components in spherical form are described for example in European Patent Applications EP-A-395083, EP-A-553805, EP-A-553806, EPA601525 and WO98/44001.

The solid catalyst components obtained according to the above method show a surface area (by B.E.T. method) generally between 20 and 500 m²/g and preferably between 50 and 400 m²/g, and a total porosity (by B.E.T. method) higher than 0.2 cm³/g preferably between 0.2 and 0.6 cm³/g. The porosity (Hg method) due to pores with radius up to 10,000 Å generally ranges from 0.3 to 1.5 cm³/g, preferably from 0.45 to 1 cm³/g.

The solid catalyst component has an average particle size ranging from 5 to 120 μm and more preferably from 10 to 100 μm.

In any of these preparation methods the desired electron donor compounds can be added as such or, in an alternative way, it can be obtained in situ by using an appropriate precursor capable to be transformed in the desired electron donor compound by means, for example, of known chemical reactions such as etherification, alkylation, esterification, etc.

Regardless of the preparation method, the final amount of electron donor compounds is such that the molar ratio with respect to the MgCl₂ is from 0.01 to 1, preferably from 0.05 to 0.5.

The amount of Ti atoms in the catalyst component preferably ranges from 1 to 10% wt, more preferably from 1.5 to 8% and especially from 2 to 5% with respect to the total weight of said catalyst component.

The organo aluminum compound is preferably an alkyl-Al compound. It is preferably selected from the trialkyl aluminum compounds such as for example triethylaluminum, triisobutylaluminum, tri-n-butylaluminum, tri-n-hexylaluminum, tri-n-octylaluminum. It is also possible to use mixtures of trialkylaluminum's with alkylaluminum halides, alkylaluminum hydrides or alkylaluminum sesquichlorides such as AlEt₂Cl and Al₂Et₃Cl₃.

Suitable external electron-donor compounds include silicon compounds, ethers, esters, amines, heterocyclic compounds and particularly 2,2,6,6-tetramethylpiperidine and ketones. Another class of preferred external donor compounds is that of silicon compounds of formula (R₇)ₐ(R₈)_{b}Si(OR₉)_{c}, where a and b are integers from 0 to 2, c is an integer from 1 to 4 and the sum (a+b+c) is 4; R₇, R₈, and R₉, are alkyl, cycloalkyl or aryl radicals with 1-18 carbon atoms optionally containing heteroatoms. Particularly preferred are the silicon compounds in which a is 1, b is 1, c is 2, at least one of R₇ and R₈ is selected from branched alkyl, cycloalkyl or aryl groups with 3-10 carbon atoms optionally containing heteroatoms and R₉ is a C₁-C₁₀ alkyl group, in particular methyl. Examples of such preferred silicon compounds are methylcyclohexyldimethoxysilane (C donor), diphenyldimethoxysilane, methyl-t-butyldimethoxysilane, dicyclopentyldimethoxysilane (D donor), (2-ethylpiperidinyl)t-butyldimethoxy silane, (2-ethylpiperidinyl)thexyldimethoxy silane, (3,3,3 -trifluoro-n-propyl)(2-ethylpiperidinyl)dimethoxysilane, methyl(3,3,3-trifluoro-n-propyl)dimethoxysilane. Moreover, are also preferred the silicon compounds in which a is 0, c is 3, R₈ is a branched alkyl or cycloalkyl group, optionally containing heteroatoms, and R₉ is methyl. Examples of such preferred silicon compounds are cyclohexyltrimethoxysilane, t-butyltrimethoxysilane and thexyltrimethoxysilane.

The external electron donor compound is used in such an amount to give a molar ratio between the organoaluminum compound and said external electron donor compound of from 0.1 to 500, preferably from 1 to 300 and more preferably from 3 to 100.

The polymerization process of the invention can be carried out either in liquid phase polymerization or, in gas-phase polymerization and with a hybrid liquid/gas-phase process as well.

The liquid phase polymerization can be carried out for example in slurry using as diluent a liquid inert hydrocarbon, or in bulk using the liquid monomer (propylene) as a reaction medium, or in solution using either monomers or inert hydrocarbons as solvent for the nascent polymer. The liquid phase polymerization can be carried out in various types of reactors such as continuous stirred tank reactors, loop reactors or plug-flow ones.

The gas-phase polymerization can be carried out operating in one or more fluidized or mechanically agitated bed reactors. Also, it can be carried out in a gas-phase reactor comprising two interconnected polymerization zones one of which, working under fast fluidization conditions and the other in which the polymer flows under the action of gravity.

In the hybrid polymerization, a first polymerization stage is carried out in liquid phase, preferably in bulk polymerization either in a loop reactor or in a CSTR. In a successive stage, the polymer obtained is transferred in a gas-phase reactor for completing the polymerization. When the polymerization is carried out in gas-phase the operating pressure is generally between 0.5 and 10 MPa, preferably between 1 and 5 MPa. In the bulk polymerization the operating pressure is generally between 1 and 6 MPa preferably between 1.5 and 4 MPa.

The catalyst of the present invention can be used as such in the polymerization process by introducing it directly into the reactor. In the alternative, the catalyst can be pre-polymerized before being introduced into the first polymerization reactor. The term pre-polymerized, as used in the art, means a catalyst which has been subject to a polymerization step at a low conversion degree. According to the present invention a catalyst is considered to be pre-polymerized when the amount the polymer produced is from about 0.1 up to about 1000 g per gram of solid catalyst component.

The pre-polymerization can be carried out with propylene or other olefins. In particular, it is especially preferred pre-polymerizing ethylene or mixtures thereof with one or more a-olefins in an amount up to 20% by mole. Preferably, the conversion of the pre-polymerized catalyst component is from about 0.2 g up to about 500 g per gram of solid catalyst component.

The pre-polymerization step can be carried out at temperatures from 0 to 60° C. preferably from 5 to 50° C. in liquid or gas-phase. The pre-polymerization step can be performed in-line as a part of a continuous polymerization process or separately in a batch process. When performing batch pre-polymerization, prepolymerizing the catalyst of the invention with ethylene in order to produce an amount of polymer ranging from 0.5 to 20 g per gram of catalyst component is particularly preferred.

As explained, the process is for the preparation of high purity propylene (co)polymers optionally containing other olefins. As an example it can be used for the production of crystalline propylene homo or copolymers containing up to 10 % of comonomer such as ethylene, butene-1 or hexene-1. Particularly preferred are the propylene homopolymers, useful for the preparation of high purity bioriented films (BOPP), which are characterized, in addition to high purity, by xylene insoluble fraction of at least 94%, medium/broad molecular weight distribution expressed by a rheological polydispersity index of at least 4.

The following examples are given in order to better illustrate the invention without limiting it.

### Characterization

### Determination of X.I.

2.5 g of polymer and 250 ml of o-xylene were placed in a round-bottomed flask provided with a cooler and a reflux condenser and kept under nitrogen. The obtained mixture was heated to 135° C. and was kept under stirring for about 60 minutes. The final solution was allowed to cool to 25° C. under continuous stirring, and the insoluble polymer was then filtered. The filtrate was then evaporated in a nitrogen flow at 140° C. to reach a constant weight. The content of said xylene-soluble fraction is expressed as a percentage of the original 2.5 grams and then, by difference, the X.I. %.

### Determination of Mg, Ti₍ₜₒₜ₎ and Al

has been carried out via inductively coupled plasma emission spectroscopy (ICP) on a “TCP SPECTROMETER ARL Accuris”.

The sample was prepared by analytically weighting, in a “fluxy” platinum crucible”, 0.1÷03 g of catalyst and 3 gr of lithium metaborate/tetraborate 1/1 mixture. The crucible is placed on a weak Bunsen flame for the burning step and then after addition of some drops of KI solution inserted in a special apparatus “Claisse Fluxy” for the complete burning. The residue is collected with a 5% v/v HNO₃ solution and then analyzed via ICP at the following wavelength: Magnesium, 279.08 nm; Titanium, 368.52 nm; Aluminum, 394.40 nm.

### Determination of Cl:

has been carried out via potentiometric tritration.

### Polydispersity Index (P.I.)

Determined at a temperature of 200° C. by using a parallel plates rheometer model RMS-800 marketed by RHEOMETRICS (USA), operating at an oscillation frequency which increases from 0.1 rad/sec to 100 rad/sec. The value of the polydispersity index is derived from the crossover modulus by way of the equation:

P.I.=10⁵/Gc

in which Gc is the crossover modulus defined as the value (expressed in Pa) at which G′=G″ wherein G′ is the storage modulus and G″ is the loss modulus.

### EXAMPLES

### Procedure for Preparation of the Spherical Adducts A and B

An initial amount of microspheroidal MgCl₂. 2.8C₂H₅OH was prepared according to the method described in Example 2 of WO98/44009, but operating on larger scale. This adduct is called adduct A. The solid adduct A was then subject to thermal dealcoholation at increasing temperatures from 30 to 130° C. and operating in nitrogen current until reaching an alcohol content of 2.1 moles per mol of MgCl₂. This partially dealcoholated adduct is called adduct B.

### Preparation of Solid Catalyst Component 1 (ID=3-methyl-2,4-pentanediol dibenzoate)

Into a 500 ml round bottom flask, equipped with mechanical stirrer, cooler and thermometer 250 ml of TiCl₄ were introduced at room temperature under nitrogen atmosphere. After cooling to 0° C., while stirring, 12.5 g of Adduct B and 3-methyl-2,4-pentanediol dibenzoate (Mg/ID=8 mole ratio) were sequentially added into the flask. The temperature was raised to 120° C. and maintained for 2 hour. Thereafter, stirring was stopped, the solid product was allowed to settle and the supernatant liquid was siphoned off maintaining the temperature at 120° C. After the supernatant was removed, additional fresh TiCl₄ was added to reach the initial liquid volume again. The mixture was heated to 120° C. again and kept at this temperature for 1 hour. Stirring was stopped again, the solid was allowed to settle and the supernatant liquid was siphoned off. The titanation step was repeated one more time at 120° C. for 1 hour.

After siphoning off the liquid phase of the third titanation, the solid was washed with anhydrous hexane six times (6×100 ml) in temperature gradient down to 60° C. and one time (100 ml) at room temperature. The obtained solid was then dried under vacuum, analyzed and used in the polymerization of propylene. The catalyst contains 4.1% wt of Ti, and 4.7% wt of the internal donor.

### Preparation of Solid Catalyst Component 2 (ID=2-methyl-4,6-heptanediol dibenzoate)

The procedure described above for solid catalyst component 1 was repeated, using 2-methyl-4,6-heptanediol dibenzoate as internal donor, at a molar ratio Mg/ID=9.

The obtained solid catalyst component contains 3.8% wt of Ti, and 6.6% wt of internal donor.

### Preparation of Solid Catalyst Component 3 (ID=2,6-dimethyl-3,5-heptanediol bis(4-n-propylbenzoate))

The procedure described above for solid catalyst component 1 was repeated, using 2,6-dimethyl-3,5-heptanediol bis(4-n-propylbenzoate) as internal donor, at a molar ratio Mg/ID=9.5.

The obtained solid catalyst component contains 4.0% wt of Ti, and 9.3% wt of internal donor.

### Preparation of Solid Catalyst Component 4 (ID=2,4-pentanediol bis(4-n-propylbenzoate))

The procedure described above for solid catalyst component 1 was repeated, using 2,4-pentanediol bis(4-n-propylbenzoate) as internal donor, at a molar ratio Mg/ID=9.5.

The obtained solid catalyst component contains 3.7% wt of Ti, and 10.4% wt of internal donor.

### Preparation of Solid Catalyst Component 5 (Comparative. ID−2-i-pentyl-2-i-propyl-1,3-propanediol dibenzoate)

The procedure described above for solid catalyst component 1 was repeated, using 2-i-pentyl-2-i-propyl-1,3-propanediol dibenzoate as internal donor, at a molar ratio Mg/ID=8.

Two titanation steps were used, the first one being at 100° C. for 2 hours, the second at 120° C. for 1 hour.

The obtained solid catalyst component contains 4.6% wt of Ti, and 22.2% wt of internal donor.

### Preparation of Solid Catalyst Component 6 (Comparative. ID=2,2,4-trimethyl-1,3-pentanediol dibenzoate)

The procedure described above for solid catalyst component 5 was repeated, using 2,2,4-trimethyl-1,3-pentanediol dibenzoate as internal donor, at a molar ratio Mg/ID=6. Now, Adduct A was used as magnesium precursor in the catalyst preparation.

The obtained solid catalyst component contains 4.7% wt of Ti, and 14.4% wt of internal donor.

### Preparation of Solid Catalyst Component 7 (Comparative. ID=2,2,4-trimethyl-1,3-pentanediol dibenzoate)

The procedure described above for solid catalyst component 1 was repeated, using 2,2,4-trimethyl-1,3-pentanediol dibenzoate as internal donor, at a molar ratio Mg/ID=9. Adduct B was used as magnesium precursor in the catalyst preparation.

The obtained solid catalyst component contains 3.7% wt of Ti, and 3.0% wt of internal donor.

### General Procedure for the Polymerization of Bulk Propylene

A 4-litre steel autoclave equipped with a stirrer, pressure gauge, thermometer, catalyst feeding system, monomer feeding lines and thermostating jacket, was purged with nitrogen flow at 70° C. for one hour. Then, at 30° C. under propylene flow, were charged in sequence with 75 ml of anhydrous hexane, the desired amount of AlEt3, an amount of dicyclopentyldimethoxysilane as external electron donor (ED) to reach the desired molar ratio Al/ED, and approximately 5 mg of solid catalyst component. The autoclave was closed; subsequently 2.0 NL of hydrogen were added. Then, under stirring, 1.2 kg of liquid propylene was fed. The temperature was raised in five minutes to 70° C., and the polymerization was carried out at this temperature for two hours. At the end of the polymerization, the non-reacted propylene was removed; the polymer was recovered and dried at 70° C. under vacuum for three hours. Then the polymer was weighed and fractionated with o-xylene to determine the amount of the xylene insoluble (X.I.) fraction.

### Examples 1-7, and Comparative Examples C1-C16

The above described solid catalyst components were used in bulk polymerization of propylene, applying the above described method for polymerization. The amount of aluminum alkyl used in polymerization was varied. The used amounts of AlEt₃, the applied molar ratios Al/ED and the results of the polymerizations with the various solid catalyst components, are listed in Table 1.

The values for aluminum, magnesium and chlorine in the table, are the calculated values, based on the amount of polymer that was produced, the composition of the solid catalyst component, and the amount of aluminum alkyl used in polymerization.

TABLE 1

| | Cat. | TEAL/C3 | Al/ED | Mileage | XI | MIL | Al | Cl | Mg |
|---|---|---|---|---|---|---|---|---|---|
| EX. | Comp. | mmole/kg | molar | kg/g | % wt | g/10′ | ppm | ppm | ppm |
| C1 | catalyst 1 | 2.11 | 20 | 81 | 95.8 | 2.7 | 178 | 7.9 | 2.3 |
| 1 | | 0.35 | 10 | 86 | 94.0 | 3.2 | 30 | 7.4 | 2.1 |
| 2 | | 0.22 | 5 | 88 | 94.1 | 3.6 | 23 | 7.3 | 2.1 |
| C2 | catalyst 2 | 2.11 | 20 | 87 | 95.7 | 3.3 | 159 | 7.2 | 2.1 |
| 3 | | 0.35 | 10 | 105 | 94.6 | 4.5 | 21 | 5.7 | 1.6 |
| C3 | catalyst 3 | 2.11 | 20 | 106 | 96.4 | 5.2 | 110 | 5.8 | 1.6 |
| 4 | | 0.35 | 20 | 135 | 94.1 | 4.9 | 17 | 4.5 | 1.3 |
| C4 | Catalyst 4 | 2.11 | 20 | 134 | 98.0 | 1.6 | 134 | 4.5 | 1.3 |
| 5 | | 0.88 | 20 | 162 | 97.7 | 0.8 | 29 | 3.7 | 1.1 |
| 6 | | 0.35 | 20 | 156 | 97.2 | 3.3 | 13 | 3.8 | 1.1 |
| 7 | | 0.22 | 20 | 156 | 96.0 | 1.7 | 10 | 3.8 | 1.1 |
| C5 | Catalyst 5 | 2.11 | 20 | 22 | 92.1 | 6.7 | 593 | 25 | 6.5 |
| C6 | | 0.88 | 20 | 24 | 87.3 | 9.2 | 128 | 17 | 4.5 |
| C7 | | 0.35 | 20 | 23 | 91.0 | 5.3 | 117 | 24 | 6.2 |
| C8 | | 0.22 | 20 | 22 | 89.7 | 6.4 | 68 | 25 | 6.5 |
| C9 | Catalyst 6 | 2.11 | 20 | 36 | 94.3 | 3.2 | 470 | 16 | 4.4 |
| C10 | | 0.88 | 20 | 38 | 93.9 | 3.3 | 176 | 15 | 4.2 |
| C11 | | 0.35 | 20 | 33 | 91.6 | 5.5 | 95 | 17 | 4.8 |
| C12 | | 0.22 | 20 | 39 | 89.5 | 6.1 | 39 | 14 | 3.9 |
| C13 | Catalyst 7 | 2.11 | 20 | 50 | 92.9 | 5.9 | 252 | 12.6 | 3.6 |
| C14 | | 0.88 | 20 | 48 | 90.7 | 6.2 | 123 | 13.1 | 3.8 |
| C15 | | 0.35 | 20 | 58 | 86.1 | N.D. | 36 | 9.3 | 2.7 |
| C16 | | 0.22 | 20 | 53 | 87.1 | 11 | 24 | 10.1 | 2.9 |

1. A process for the preparation of high purity propylene (co)polymers comprising (co)polymerizing propylene in the presence of a catalyst system comprising the product obtained by reacting:
an organo-aluminum compound, with
a solid catalyst component comprising Mg, Ti and electron donor compound of the following formula (A) 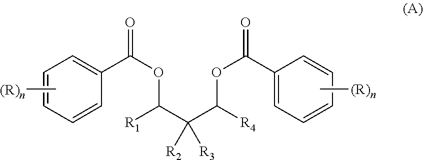
in which R₁-R₄ groups, equal to or different from each other, are hydrogen or C₁-C₁₅ hydrocarbon groups, optionally containing a heteroatom selected from halogen, P, S, N and Si, with the proviso that R₁ and R₄ are not hydrogen; R groups equal to or different from each other, are selected from C₁-C₁₅ hydrocarbon groups which can be optionally linked to form a cycle and n is an integer from 0 to 5, and optionally
an external electron donor compound,
said process being carried out employing an organo-aluminum/propylene ratio equal to or lower than 1.75 mmol/kg.

2. The process according to claim 1 in which the process is carried out at organo-aluminum/propylene ratio lower than 0.9 mmol/kg.

3. The process according to claim 1 in which in the donor of formula (A) R1 and R4 are independently selected from C1-C15 alkyl groups, C6-C14 aryl groups, C3-C15 cycloalkyl groups, and C7-C15 arylalkyl or alkylaryl groups.

4. The process according to claim 1 in which R1 and R4 are selected from C1-C10 alkyl groups.

5. The process according to claim 1 in which R1 and R4 are both methyl.

6. The process according to claim 1 in which R2-R3 groups independently are selected from hydrogen or C1-C10 alkyl groups.

7. The process according to claim 1 in which both R2 and R3 groups, are hydrogen.

8. The process according to claim 1 in which R groups are selected from C1-C15 alkyl groups, C6-C14 aryl groups, C3-C15 cycloalkyl groups, and C7-C15 arylalkyl or alkylaryl groups.

9. The process according to claim 1 in which R groups are selected from C1-C5 alkyl groups.

10. The process according to claim 1 in which the index n ranges from 1 to 3.

11. The process according to claim 1 in which n is 1 and the substituent R is in position 4 of the benzoate ring.

12. The process according to claim 1 in which the organo-aluminum compound is an alkyl-Al compound.

13. The process according to claim 1 in which the alkyl-Al compound is a trialkyl-aluminum selected from triethylaluminum, triisobutylaluminum, tri-n-butylaluminum, tri-n-hexylaluminum, tri-n-octylaluminum and mixture thereof.

14. The process according to claim 1 in which the external electron donor is selected from silicon compounds of formula (R7)a(R8)bSi(OR9)c, where a and b are integers from 0 to 2, c is an integer from 1 to 4 and the sum (a+b+c) is 4; R7, R8, and R9, are alkyl, cycloalkyl or aryl radicals with 1-18 carbon atoms optionally containing heteroatoms.

15. The process according to claim 1 carried out in one or more gas-phase reactors.
